(19) United States
(12) Patent Application Publication
(10) Pub. No.: US 2007/0228166 A1
(43) Pub. Date: Oct. 4, 2007

(54) SYSTEM FOR DETECTING COUTERFEITING PRODUCTS USING CAMERA

(76) Inventor: Ho Chung Lui, Hong Kong (CN)

Correspondence Address: EAGLE IP LIMITED, UNIT 1201, 12/F KWAI HUNG HOLDINGS CENTRE, 89 KING'S ROAD, NORTH POINT, HONG KONG, omitted

(21) Appl. No.: 11/695,069

(22) Filed: Apr. 2, 2007

Related U.S. Application Data
(60) Provisional application No. 60/744,200, filed on Apr. 4, 2006.

(51) Int. Cl. G06K 7/10

(52) U.S. Cl. 235/454

(57) ABSTRACT

The present invention is a system and method to detect counterfeiting goods. In this invention, the user initiates the counterfeiting check by using a wireless device equipped with camera in his possession to take a picture of the anti-counterfeiting code pattern of a product item; and send the digital image to a host computer for checking. This invention further includes a second anti-counterfeiting code for user to examine so as to further ensure the authenticity of the product item.

### CROSS-REFERENCE TO RELATED APPLICATION

This application claims benefit under 35 U.S.C. § 119(e) of U.S. Provisional Application having Ser. No. 60/744,200 filed Apr. 4, 2006, which is hereby incorporated by reference herein in its entirety.

### FIELD OF INVENTION

This invention relates an anti-counterfeiting solution so that the users or law-enforcement agents can verify whether the goods that they are examining are genuine and not counterfeit.

### BACKGROUND OF INVENTION

Counterfeiting goods have been present for centuries and are a major concern that affects not only the producers but also the consumers. Many industries suffer heavily from cheap and low-quality counterfeits. Consumers are often cheated, as they do not know that they have purchased low-quality counterfeits. This is particularly serious in the pharmaceutical industry. Patients' lives are at risk if they are administered with counterfeit drugs.

Yet despise concerted effort from the government agents, manufacturers and the retailers to combat counterfeits, there is no signs that they are abating. While manufacturers have adopted various methods to combat counterfeit goods, they have not been very effective so far. In general, the existing methods fall into two categories: (1) authentication technologies and (2) track and trace technologies. The former typically incorporates some sort of hard-to-duplicate materials in the product package so that the consumer can distinguish the genuine product against the faked ones. However, some of these anti-counterfeiting technologies can also be acquired even by the counterfeit producers, rendering them ineffective. As for the track and trace technologies, the purpose is to ensure that counterfeiting goods can not enter the supply chain as the products moves from the manufacturer, through the distributor, and eventually arrives at the retail shops. This can be done by either the paper or electronic pedigree to track the product shipment along the supply chain. However, maintaining an accurate shipment record or the pedigree requires major commitment and collaboration among all the parties in the supply chain and is not easily achieved. Hence both approaches have drawbacks.

### SUMMARY OF INVENTION

In the light of the foregoing background, it is an object of the present invention to provide an alternate anti-counterfeiting solution.

Accordingly, the present invention, in one aspect, is a system that detects counterfeiting products for a user. The whole system comprises (a) a product item affixed with an exterior label. That exterior label further comprises a first region that provides information about the product item and its manufacturer, and a second region that comprises an anti-counterfeiting code pattern; (b) a portable device subsystem that is possessed and trusted by the user; the subsystem further comprising a digital camera that generates a digital image when taking a picture; and a wireless communication system that is configured to receive the digital image from the digital camera and transmit the digital image to a host computer via wireless means through a digital communication network; and (c) a host computer that is trusted by the user, further configured to connect to the digital communication network to receive the digital image. The host computer is adapted to execute an image recognition software module that is configured to recognize the anti-counterfeiting code pattern within the second region of the exterior label in the product item; and a genuine product verification software module to check the anti-counterfeiting code and to verify the authenticity of the product.

In a preferred aspect of the present invention, the user can initiate the checking of the authenticity of a product item by performing the steps of: (a) taking a picture of the product label using the portable device subsystem that the user possesses and trusts; (b) sending the digital image to a host computer that the user trusts via the wireless communication system for the host computer to analyze and to report back a message to the portable device subsystem about its findings; and (c) reading the message to decide the authenticity of the product item.

In one preferred embodiment of this invention, the portable device subsystem is a cellular mobile phone equipped with digital camera. In another embodiment, this subsystem consists of a digital camera and a cellular mobile phone. The digital camera and the cellular mobile phone are equipped with a second wireless means so that the former can send the digital image to the latter using that second wireless means.

In one embodiment of the present invention, the anti-counterfeiting code pattern comprises printed characters and symbols, and the image recognition software module in the host computer is adapted to extract the anti-counterfeiting code by performing the following tasks on the digital image: (a) locating the area in the second region that contains the anti-counterfeiting code pattern; (b) segmenting each individual character pattern from the anti-counterfeiting code pattern; (c) submitting the individual character pattern to a character recognizer to recognize the character; the character recognizer outputting a character code for the character pattern; (d) concatenating the character code together to form the anti-counterfeiting code string; and (e) applying post-processing module to the anti-counterfeiting code string to verify the correctness of the anti-counterfeiting code; the post-processing module further outputting the anti-counterfeiting code to the genuine product verification software module.

In another aspect of the present invention, the product item further comprises a container with a removable cover means and a second label residing inside the container with a second anti-counterfeiting code printed on it. The removable covering means is used to seal the container to protect the content of the product item. In operation, when the host computer reports the findings to the user after examining the exterior label, it further sends a message containing the second anti-counterfeiting code to the portable device subsystem. The user can further perform steps of: (a) opening the removable cover that seals a container; (b) retrieving the second label that contains a printed copy of the second anti-counterfeiting code; and (c) comparing the anti-counterfeiting code sent by the host computer against the second label and check if they are identical.

There are many advantages to the present invention. First of all, this invention offers a new system and method in which it is the user who initiates the anti-counterfeiting examination on the product that he is examining. The user uses a wireless portable device that he trusts to submit a request to a host computer that he trusts in order to check the genuineness of the product. This eliminates potential loopholes that the retailer conspires with the counterfeit manufacturers in supplying faked anti-counterfeiting equipment to fool the user.

Another important advantage of this invention is that it can provide a simple and yet effective procedure to protect both the manufacturers and the users. When the product item is equipped with both the exterior label and the second label inside a sealed container, only the manufacturer knows the secret of the two anti-counterfeiting codes that are associated with the product item. Even if the counterfeiter gets hold of the anti-counterfeiting code for the exterior label, he can't acquire the other code unless he opens up the sealed container.

A further advantage of this inventive scheme is that it makes use of the existing computing and telecommunicating infrastructure as much as possible so as to avoid the costly and lengthy IT infrastructure build-up before the anti-counterfeiting service can be launched.

### BRIEF DESCRIPTION OF FIGURES

FIG. 1 is an architecture diagram of the system that detects counterfeiting products according to the preferred embodiment of the present invention.

FIGS. 2A and 2B show the detailed arrangement of the second region in the exterior label that includes the anchor markers, the special symbols and the anti-counterfeiting code pattern.

FIG. 3 shows the software flow chart of the image recognition software module.

FIG. 4 is an illustration of a typical product with product label affixed onto it.

FIG. 5 shows one possible way to adhere the second label to the interior of the container of the product item.

### DETAILED DESCRIPTION OF THE PREFERRED EMBODIMENTS

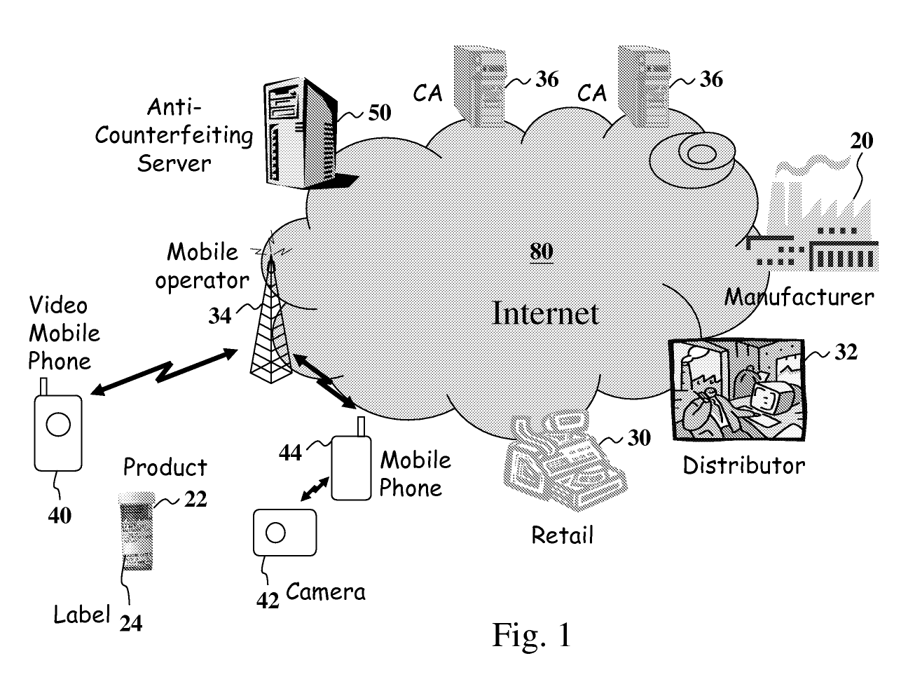

Referring now to FIG. 1, the first embodiment of the present invention is a system and method of offering anti-counterfeiting service to the user. The user here refers not only to consumer but also a professional such as law-enforcement officers. A user (not shown in the figure) wants to examine if product item 22 is actually made by manufacturer 20. He uses a video mobile phone 40 that is equipped with a camera to take a picture of the label 24 of the product item 22. The label contains an anti-counterfeiting code pattern that will be described later. The video mobile phone 40 then sends the digital image of the label to an Anti-Counterfeiting Server (ACS) 50 via the mobile operator 34 and through the Internet 80. The ACS 50 will invoke an image recognition software module to recognize the anti-counterfeiting code pattern; and submit the anti-counterfeiting code to a genuine product verification (GPV) software module. The later uses the anti-counterfeiting code to verify the genuineness of the product item; and send its report back to the video mobile phone 40 to inform the user. The GPV module may, through the Internet 80, query the manufacturer 20, the distributor 32, or the retailer 30 along the product delivery supply chain to reach its conclusion. To further ensure that the information provided by the manufacture 20, the distributor 32 and the retailer 30 is genuine, the GPV module may require that the information they provided is digitally signed by the certificate authorities (CA) 36 via the Internet. ACS may enquire the CAs 36 via the Internet to retrieve the relevant digital certificates to verify the digital signatures of the messages.

In another embodiment, the user can use a camera 42 equipped with a second wireless means to send a digital image to a mobile phone 44. The later forwards the digital image to ACS 50 via the mobile operator 34 and the Internet 80. The second wireless means can either be based on radio frequency (RF) such as Bluetooth or Wireless LAN, Ultra-Wide Band (UWB) technology, WiMAX, or infrared or ultra-sound.

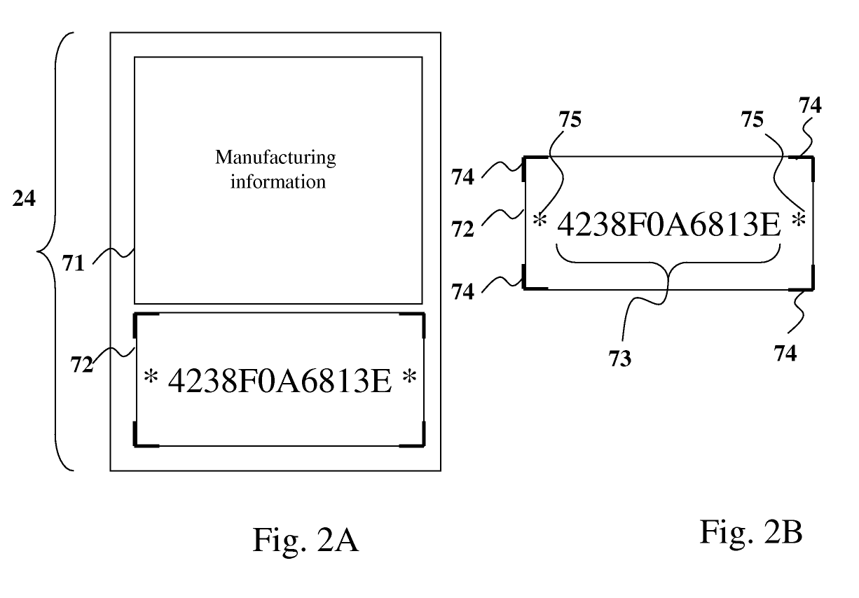

Product label 24 may comprise a plurality of regions as shown in FIG. 2A. One of which contains the manufacturing information 71 that includes, but not limited to, the product name, manufacturer logo, product description, ingredient, manufacturing and expiration dates, . . . , etc. Product label 24 also contains an Anti-Counterfeiting Code Region (ACCR) 72. In a preferred embodiment, the ACCR 72 further comprises a plurality of anchor markers (hereto referred as ACCR markers) 74; a plurality of ACCR special symbols 75; and the anti-counterfeiting code pattern 73. The ACCR markers 74 are printed symbols to facilitate the image recognition software module to easily locate the ACCR 72. These markers 74 can be placed at the boundary of the ACCR 72 as shown in FIGS. 2A and 2B. The ACCR special symbol 75 is another printed symbol placed next to the anti-counterfeiting code pattern 73. When the image recognition software module locates this symbol, it can find the code pattern 73 by searching the neighborhood of this symbol. In a preferred embodiment, the anti-counterfeiting code pattern comprises a string of one or more printed alphanumeric characters. In an even preferred embodiment, it is a hexadecimal character string. This code comprises an ID code that can unique identify the product item 22. For example, this can be the EPC (Electronic Product Code). It can further contain other relevant information such as error detection or error correction codes, the Internet address of the manufacturer and also the digital signature of the above.

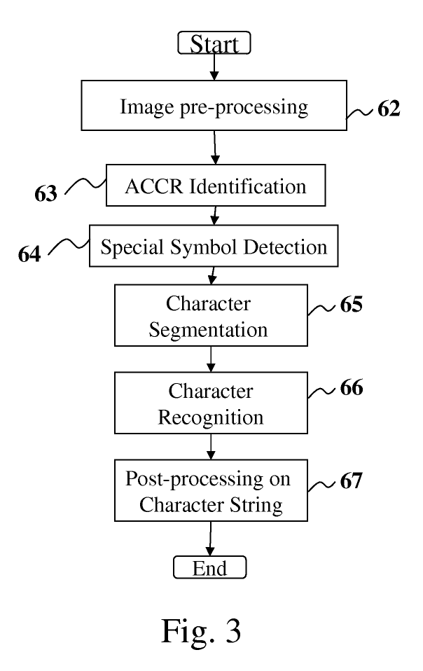

FIG. 3 shows the flow chart of the image recognition software module in one specific implementation of the present invention. It first performs image pre-processing step 62 on the digital image that it receives. This can include noise filtering, edge enhancement, histogram equalization or other image processing techniques. Next control is passed to the ‘ACCR Identification’ step 63 to locate the ACCR within the digital image. This can be done by first locating the ACCR markers. Once located, the software module can perform a search of the ACCR special symbol 75 in step 64. After detecting the special symbol 75, then the anti-counterfeiting code pattern 73 can be located. Notice that the ACCR marker 74 and the ACCR special symbol 75 are used to facilitate the image recognition module to quickly locate the anti-counterfeiting code pattern 73. Afterwards, the individual character pattern can be segmented out in step 65; and this character pattern is passed to a character recognizer 66. The output of step 66 is a character code that is fed to the post-processing step 67. This step is to concatenate the individual characters together to form a character string. If the anti-counterfeiting code contains check-sum characters, this step can perform the check-sum calculation for error detection. In another preferred embodiment, it can also perform error correction if the anti-counterfeiting code incorporates forward-error correction coding. Afterwards, the post-processing step 67 package the anti-counterfeiting code together and send to the GPV module.

Based on the anti-counterfeiting code, the GPV module performs the verification in a variety ways. In one embodiment where the ACS 50 contains a database of anti-counterfeiting code and product status from the manufacturer 20, this module can verify that the code exists in such database, and the product item 22 hasn't been purchased before. In another embodiment, where the anti-counterfeiting code contains the Internet address of the manufacturer, this module can submit the anti-counterfeiting code to the manufacturer, and request the manufacturer to verify the genuineness of the product item. In another preferred embodiment, the anti-counterfeiting code includes the digital signature of the manufacturer supplied information. The GPV module can use the manufacturer's digital certificate from the CA 36 to verify the digital signature in the anti-counterfeiting code and hence ensure that manufacturer supplied information is genuine.

In another embodiment, the GPV module can also obtain the pedigree of the product item by tracing the product shipment route from the manufacture through the distributor to the retailer. This can be done by first asking the manufacture to supply information on where the product item is shipped to, and then ask the first recipient for the next recipient address and so on.

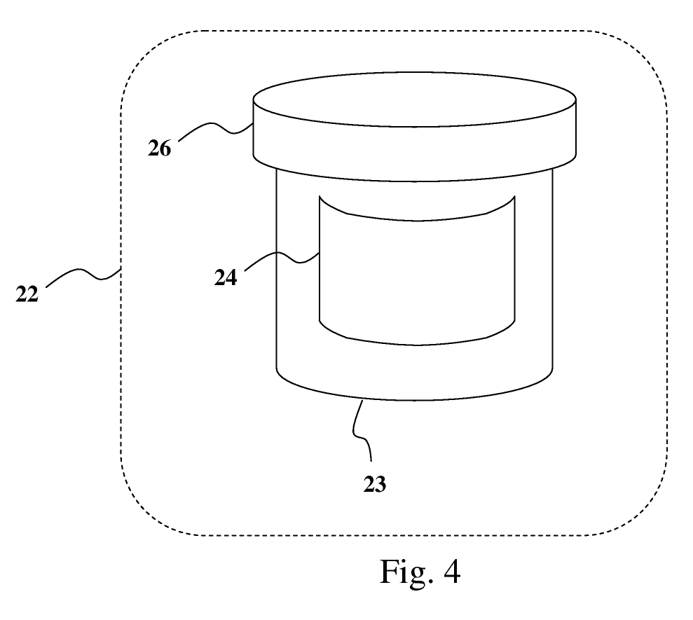

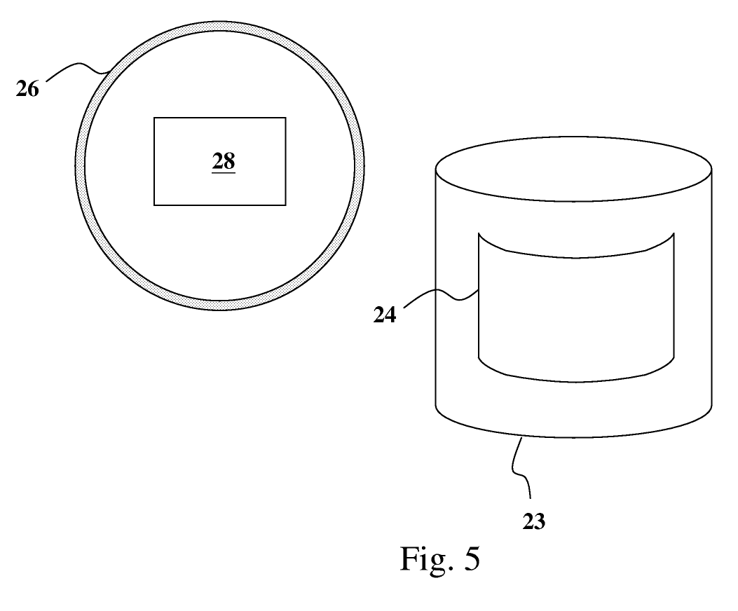

In one aspect of the present invention, the product item 22 has a container 23 with a removable cover 26 that seals the content of the product item as shown in FIG. 4. The label 24 is affixed to the container 23. A more sophisticated verification scheme using addition secret can be employed to make this invention more counterfeit-proof. As shown in FIG. 5, a second label 28 that contains a second anti-counterfeiting code is affixed at the back of the removable cover 26. When ACS 50 finds that the first anti-counterfeiting code is genuine, it further sends the second anti-counterfeiting code to the video mobile phone 40 or the mobile phone 44 to request the user to open up the removable cover 26 and read up the second anti-counterfeiting code 28; and compare with the one that is sent by ACS 50 to further verify the genuineness of the product item.

The preferred embodiments of the present invention are thus fully described. Although the description referred to particular embodiments, it will be clear to one skilled in the art that the present invention may be practiced with variation of these specific details. Hence this invention should not be construed as limited to the embodiments set forth herein. For example, the anti-counterfeiting code pattern can be a two-dimensional bar-code pattern with the anti-counterfeiting code encoded in it. The image recognition software module is then adapted to recognize the two-dimensional bar-code pattern. Moreover, it is not absolutely necessary to have either the ACCR marker 74 or the ACCR special symbol 75, or both of them in the ACCR 72 as long as the image recognition software module is capable to locate the anti-counterfeiting code pattern reliably and quickly. As the video mobile phone 40 becomes more and more advanced, many of the image processing steps in FIG. 3 can be performed by this device. For example, the ACCR identification step 63 can be done by the video mobile phone 40, so that only the ACCR 72 is sent over to ACS 50. This will reduce the data transmission time and also the cost associated with it. Lastly, the entire image processing steps may be done at the video mobile phone 40; and only the recognized anti-counterfeiting code is sent to ACS 50.

What is claimed is:

1. A system for detecting counterfeiting products for a user comprising
a) an exterior label adapted to attach to the exterior of a product item; said exterior label further comprising a first region that provides information about said product item and its manufacturer, and a second region that comprises an anti-counterfeiting code pattern;
b) a portable device subsystem that is possessed by said user and is trusted by said user, further comprising
i) a digital camera that generates a digital image when taking a picture; and
ii) a wireless communication system that is configured to receive said digital image from said digital camera and transmit said digital image to a host computer via wireless means through a digital communication network;
c) a host computer that is trusted by said user, further configured to connect to said digital communication network to receive said digital image; said host computer is adapted to execute
i) an image recognition software module that is configured to recognize said anti-counterfeiting code pattern within said second region of said exterior label in said product item; and
ii) a genuine product verification software module to check said anti-counterfeiting code and to verify the authenticity of said product
so that said user can use said digital camera to take a picture of said second region on said exterior label of said product and use said wireless communication system to send said digital image to said host computer; and said host computer activates said image recognition software module to recognize said anti-counterfeiting code pattern in said second region and invokes said genuine product verification software to verify that said product is actually produced by said manufacturer, and reporting its findings to said user via said portable device using said wireless means.

2. A system according to claim 1 wherein said portable device subsystem is a cellular mobile phone equipped with digital camera.

3. A system according to claim 1 wherein
a) said digital camera in said portable device subsystem further comprises a second wireless means for sending said digital image to said wireless communication system; and
b) said digital communication system in said portable device subsystem is a cellular mobile phone configured to include said second wireless means to receive said digital image from said digital camera.

4. A system according to claim 1 wherein said anti-counterfeiting code pattern comprises printed characters and symbols, and said image recognition software module in said host computer is adapted to extract said anti-counterfeiting code by performing the following tasks on said digital image:
a) locating the area in said second region that contains said anti-counterfeiting code pattern;
b) segmenting each individual character pattern from said anti-counterfeiting code pattern;
c) submitting said individual character pattern to a character recognizer to recognize said character; said character recognizer outputting a character code for said character pattern;
d) concatenating said character code together to form said anti-counterfeiting code string; and
e) applying post-processing module to said anti-counterfeiting code string to verify the correctness of said anti-counterfeiting code; said post-processing module further outputting said anti-counterfeiting code to said genuine product verification software module.

5. A system according to claim 6 wherein said post-processing module is adapted to detect any errors in the anti-counterfeiting code string; said module further prompting said user to enter the correct anti-counterfeiting code if said error occurs.

6. A system according to claim 7 wherein said post-processing module is further adapted to correct errors in the anti-counterfeiting code string using forward error correction algorithm.

7. A system according to claim 1 wherein said anti-counterfeiting code further comprises product code that uniquely identifies said product item of said manufacturer;

8. A system according to claim 7 wherein said genuine product verification software module in said host computer is adapted to
a) receiving said anti-counterfeiting code from said image recognition software module;
b) checking said anti-counterfeiting code against a product code database submitted by said manufacturer to said host computer; and
c) reporting to said user that said product item is genuine if said anti-counterfeiting code exists in said product code database;

9. A system according to claim 7 wherein said anti-counterfeiting code further comprises a unique Internet address of said manufacturer.

10. A system according to claim 10 wherein said genuine product verification software module in said host computer is adapted to
a) receiving said anti-counterfeiting code from said image recognition software module;
b) extracting said product code and said unique Internet address of said manufacturer from said anti-counterfeiting code;
c) sending said product code to said unique Internet address of said manufacturer;
d) receiving a response from said manufacturer on the decision of the genuineness of said product item; and
e) reporting said decision to said user.

11. A system according to claim 9 wherein said anti-counterfeiting code further comprise a digital signature; said digital signature encrypting said product code and said unique Internet address of said manufacturer using a private security key of said manufacturer.

12. A system according to claim 11 wherein said genuine product verification software module in said host computer is adapted to
a) receiving said anti-counterfeiting code from said image recognition software module;
b) obtaining and using the public security key of said manufacturer to verify said digital signature; reporting to said user if said digital signature can not be verified and skipping the following steps; otherwise
c) extracting said product code and said unique Internet address of said manufacturer from said anti-counterfeiting code;
d) sending said product code to said unique Internet address of said manufacturer;
e) receiving a response from said manufacturer on decision of the genuineness of said product item; and
f) reporting said decision to said user

13. A system according to claim 1 wherein said product item further comprises
a) a container with a removable cover means; said removable covering means sealing said container to protect the content of said product item; and said exterior label is adhered to the exterior surface of said container; and
b) a second label residing inside said container with a second anti-counterfeiting code printed on it
so that when said host computer reports said findings to said user after examining said exterior label, it further sends a message containing said second anti-counterfeiting code to said portable device subsystem and requests said user to open said removable cover means from said container to read up said second label and to verify if said second anti-counterfeiting code printed on said second label matches with the one sent by said host computer.

14. A method initiated by a user for detecting anti-counterfeiting products comprising the steps for said user to perform of:
a) taking a picture of a product label affixed to the exterior of a product item using a portable device subsystem possessed and trusted by said user;
said product label further comprising
a first region that provides information about said product item and its manufacturer, and
a second region that comprises an anti-counterfeiting code pattern; and
said portable device subsystem comprises
a digital camera that generates a digital image when taking a picture; and
a wireless communication system that is configured to receive said digital image from said digital camera;
b) sending said digital image to a host computer that is trusted by said user via said wireless communication system; said host computer analyzing said digital image and reporting a message to said portable device subsystem about its findings; and
c) reading said message and deciding the authenticity of said product item.

15. A method according to claim 14 wherein said analyzing step of said host computer further comprising steps of:
i) invoking an image recognition software module to analyze said digital image to extract said anti-counterfeiting code from said anti-counterfeiting code pattern, and
ii) verifying said anti-counterfeiting code by a genuine product verification software module to determine the genuineness of said product item.

16. A method according to claim 15 wherein said image recognition software module is to recognize said anti-counterfeiting code pattern that is formed by printed characters and symbols; further comprising the steps of:
a) locating said anti-counterfeiting code pattern within said second region;
b) segmenting each individual character pattern from said anti-counterfeiting code pattern;
c) submitting said individual character pattern to a character recognizer to recognize said character; said character recognizer outputting a character code for said character pattern;
d) concatenating said character code together to form said anti-counterfeiting code string; and
e) applying post-processing module to said anti-counterfeiting code string to verify the correctness of said anti-counterfeiting code; said post-processing module further outputting said anti-counterfeiting code to said genuine product verification software module.

17. A method according to claim 16 wherein said step of locating said anti-counterfeiting code pattern further comprises the step of identifying at least one anchor marker from said digital image to locate said second region; wherein said at least one anchor marker is printed on the boundary of said second region.

18. A method according to claim 16 wherein said step of locating said anti-counterfeiting code pattern further comprises the step of locating at least one special symbol; wherein said special symbol is a printed symbol situated next to said anti-counterfeiting code pattern.

19. A method according to claim 14 wherein said host computer further comprising the step of sending a second anti-counterfeiting code to said portable device subsystem when reporting its findings; and said user further performing steps of:
i) opening a removable cover that seals a container; said container being used to store the content of said product item
ii) retrieving a second label that contains a printed copy of said second anti-counterfeiting code; said second label can only be read by said user after said removable cover is removed; and
iii) comparing said anti-counterfeiting code sent by said host computer against said second label and check if they are identical.
